(19) United States
(12) Patent Application Publication
(10) Pub. No.: US 2007/0168983 A1
(43) Pub. Date: Jul. 19, 2007

(54) Test management program and method

(75) Inventor: Yuji Ishimura, Tokyo (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/517,994

(22) Filed: Sep. 8, 2006

(30) Foreign Application Priority Data
Sep. 8, 2005 (JP) P2005-260173

(51) Int. Cl. G06F 9/44

(52) U.S. Cl. 717/124

(57) ABSTRACT

A test management program causes a computer to execute a process, the process including selecting from among modules prepared for a plurality of platforms, a distribution definition holding module that holds a distribution definition of an event and a distribution module that distributes the event, according to a platform on which an application to be tested runs; causing the distribution module to distribute the event to the application to be tested according to the distribution definition held by the selected distribution definition holding module; and estimating the state of the application to which the event is distributed.

### CROSS-REFERENCE TO RELATED APPLICATIONS

The present application claims priority from Japanese Patent Application No. JP 2005-260173 filed on Sep. 8, 2005, the disclosure of which is hereby incorporated by reference herein.

### BACKGROUND OF THE INVENTION

1. Field of the Invention

The present invention relates to a test management program and method and in particular, to a test management program and method that can realize a module for automatic test of applications operating on a plurality of platforms in a portable form.

2. Description of the Related Art

Recently, high function promotion of CE (Consumer Electronics) apparatuses has progressed. As regards the development of software to be loaded on such a high functional CE apparatus, a test for quality assurance requires enormous steps due to a complex software configuration.

As the test for quality assurance includes, for example, there is a method that causes a person, called a validation staff, to perform various prescribed operations as test items using the remote controller of the CE apparatus, and verifies whether or not the operation is made as assumed.

Further, it takes much time for a person to perform the test. Accordingly, there is suggested a system that distributes events corresponding to operations of a remote controller to the CE apparatus and automatically verifies the operations of the CE apparatus with regard to the events (for example, see JP-A-2005-100068, JP-A-2003-296134, JP-A-2004-280231, JP-A-2004-110267, and JP-A-2002-366387)

As regards the development of large-scale software that is a combination of a plurality of software modules developed by staffs of different departments, it is difficult to combine the tests. For example, when the test contents cannot be assigned and defined for every software module, it may be impossible to verify the operations in parallel, and work efficiency is degraded.

When the same system or an application running on a system is ported to a plurality of different platforms, automatic distribution of the event or porting of a module performing the automatic test may have a problem.

For example, when verification of the same systems loaded on a television receiver and a cellular phone is performed, in particular, distribution information of the event depends on a platform, and a distribution sequence of the event varies in the platform of the television receiver and the platform of the cellular phone, which results in a difficulty in realizing portability. Then, it is necessary to prepare a module for automatic distribution or automatic test of the event for every platform of the television receiver and the cellular phone.

In addition, as regards the automatic test performed on the basis of previously prepared event distribution definition information (information defining an event distributed in which sequence), it is difficult to perform definition itself, which results in a difficulty in realizing portability.

It is desirable to realize a module for automatic test of applications running on a plurality of platforms in a portable form.

### SUMMARY OF THE INVENTION

According to an embodiment of the invention, there is provided a test management program that causes a computer to execute a process, the process including selecting from among modules prepared for a plurality of platforms, a distribution definition holding module that holds a distribution definition of an event and a distribution module that distributes the event, according to a platform on which an application to be tested runs; causing the distribution module to distribute the event to the application to be tested according to the distribution definition held by the selected distribution definition holding module; and estimating the state of the application to which the event is distributed.

The process may further include selecting from among estimation modules prepared for a plurality of applications as modules estimating the state of the application, an estimation module for the application to be tested. In this case, the selected estimate module may estimate the state of the application to which the event is distributed.

The test management program may be prepared in a computer serving as a development host of the application to be tested and may be executed by an electrical apparatus on which the application is loaded.

The test management program may be provided from the computer to the electrical apparatus through a network.

The distribution definition may be described in an XML format.

According to another embodiment of the invention, a test management method of an application includes selecting from among modules prepared for a plurality of platforms, a distribution definition holding module that holds a distribution definition of an event and a distribution module that distributes the event, according to a platform on which an application to be tested runs; causing the distribution module to distribute the event to the application to be tested according to the distribution definition held by the selected distribution definition holding module; and estimating the state of the application to which the event is distributed.

According to the embodiments of the invention, among the modules prepared for each platform, the distribution definition holding module that holds the distribution definition of the event and the distribution module that distributes the event are selected according to the platform on which the application to be tested runs. Further, according to the distribution definition held by the selected distribution definition holding module, the event is distributed to the application to be tested by the distribution module, and the state of the application to which the event is distributed is estimated.

According to the embodiments of the invention, it is possible to realize a module for automatic testing of applications running on a plurality of platforms in a portable form.

### BRIEF DESCRIPTION OF THE DRAWINGS

FIG. 1 is a diagram showing an example of an environment where a test of an application according to an embodiment of the invention is executed;

FIG. 2 is a block diagram showing an example of the hardware configuration of a DTV shown in FIG. 1;

FIG. 3 is a block diagram showing an example of the configuration of a PC shown in FIG. 1;

FIG. 4 is a diagram showing an example of data used in the PC;

FIG. 5 is a block diagram showing an example of the functional configuration that is realized in the DTV; and

FIG. 6 is a diagram illustrating a series of steps that are performed in individual functional units.

### DETAILED DESCRIPTION

Hereinafter, a preferred embodiment of the invention will be described. The constituents of the invention and the embodiment described in the specification or drawings have the following correlation. The description hereof is intended to make sure of the fact that the embodiment supporting the invention is described herein. Therefore, if there is any embodiment that, although described in the description of the preferred embodiment, is not described herein as corresponding to the constituents, this does not denote that such an embodiment does not correspond to the constituents. Conversely, if any embodiment is described herein as corresponding to the constituents, it does not denote that such an embodiment does not correspond to other constituents than the constituents.

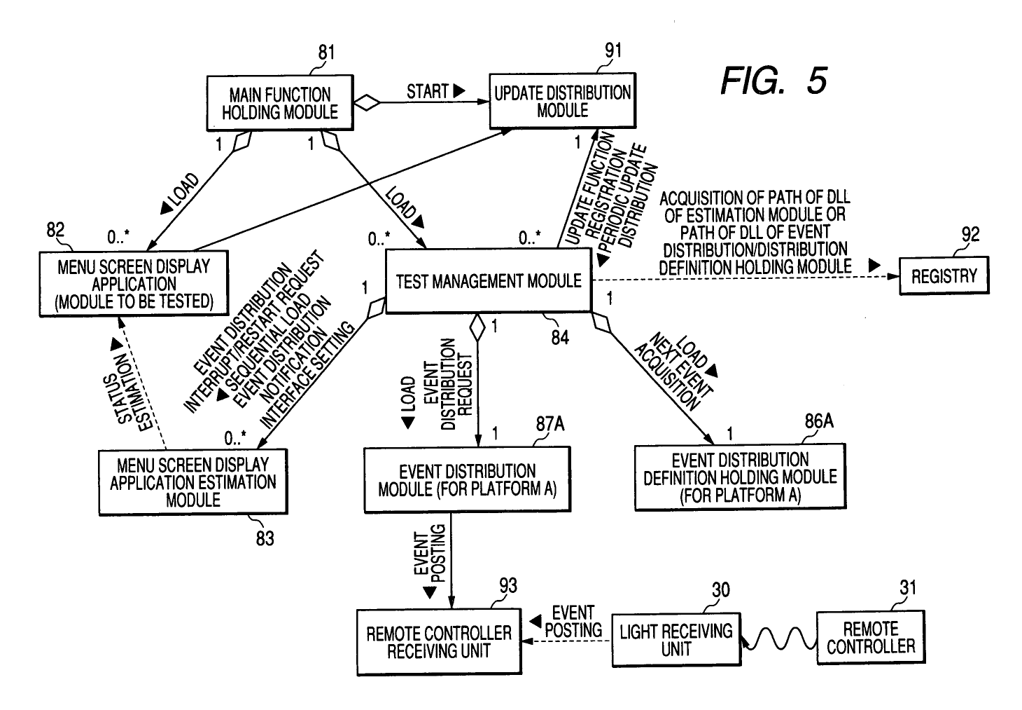

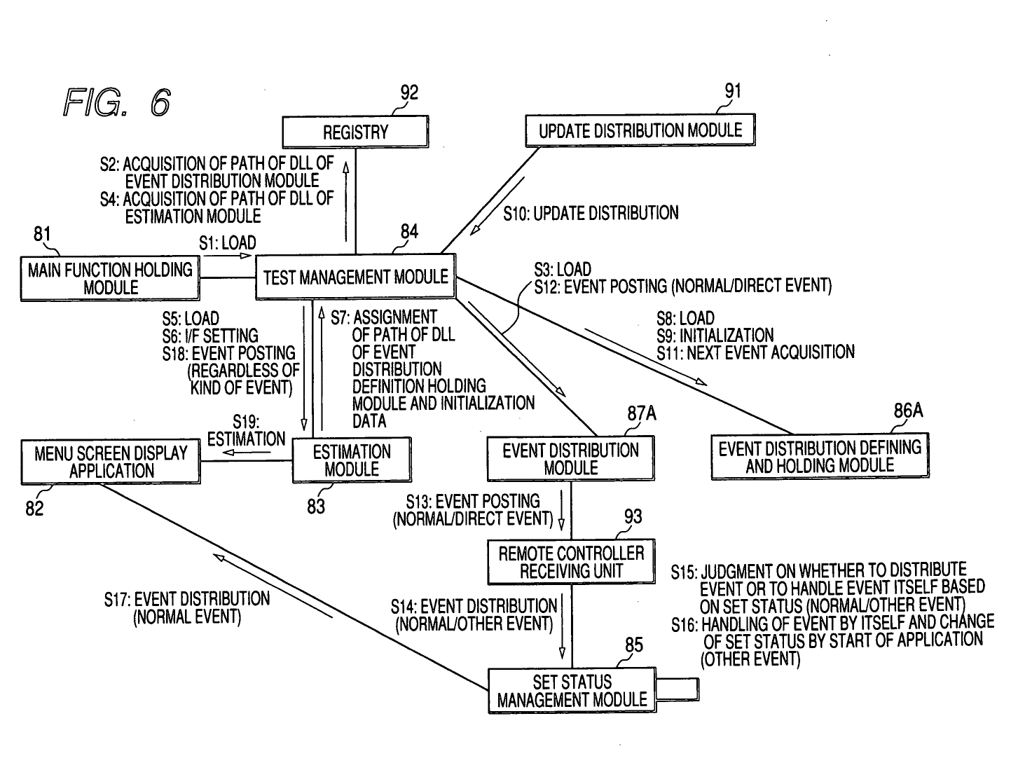

According to an embodiment of the invention, there is provided a test management program (for example, a test management module 84 of FIG. 5) that causes a computer to execute a processing including the steps of selecting, among modules prepared for every platform, a distribution definition holding module (for example, an event distribution definition holding module 86A of FIG. 5) that holds a distribution definition of an event and a distribution module (for example, an event distribution module 87A of FIG. 5) that distributes the event, according to a platform, on which an application to be tested (for example, a menu screen display application 82 of FIG. 5) runs (for example, Step S2 of FIG. 6), causing the distribution module to distribute the event to the application to be tested according to the distribution definition that is held by the selected distribution definition holding module (for example, Step S12 of FIG. 6), and estimating the state of the application to be tested, to which the event is distributed (for example, Step S19 of FIG. 6).

In the test management program according to the embodiment of the invention, the processing may further include selecting, among estimation modules prepared for every application as modules estimating the state of the application, an estimation module (for example, a menu screen display application estimation module 83 of FIG. 5) for the application to be tested (for example, Step S4 of FIG. 6).

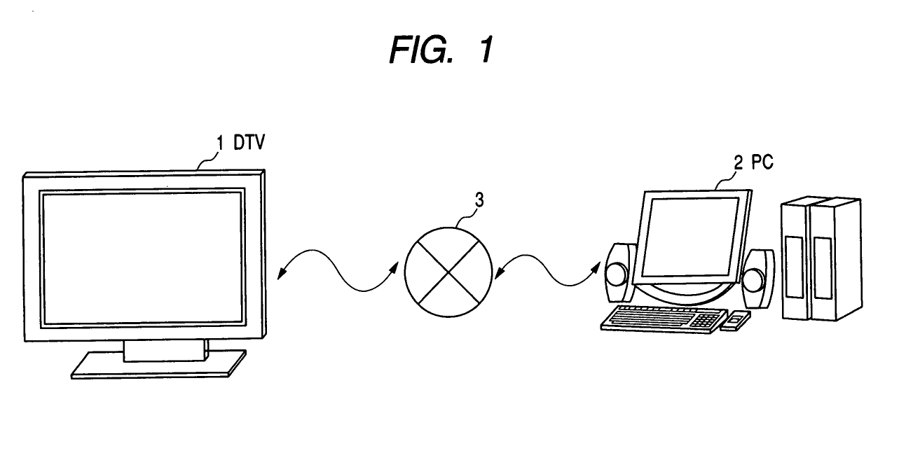

The test management program may be prepared in a computer (for example, PC 2 of FIG. 1) serving as a development host of the application to be test and may be executed by an electrical apparatus (for example, DTV 1 of FIG. 1), on which the application is loaded.

According to another embodiment of the invention, a test management method of an application includes the steps of selecting, among modules prepared for every platform, a distribution definition holding module (for example, an event distribution definition holding module 86A of FIG. 5) that holds a distribution definition of an event and a distribution module (for example, an event distribution module 87A of FIG. 5) that distributes the event, according to a platform, on which an application to be tested (for example, a menu screen display application 82 of FIG. 5) runs (for example, Step S2 of FIG. 6), causing the distribution module to distribute the event to the application to be tested according to the distribution definition that is held by the selected distribution definition holding module (for example, Step S12 of FIG. 6), and estimating the state of the application to be tested, to which the event is distributed (for example, Step S19 of FIG. 6).

Hereinafter, a preferred embodiment of the invention will be described with reference to the drawings.

FIG. 1 is a diagram showing an example of an environment where a test of an application (application program) according to an embodiment of the invention is executed.

As shown in FIG. 1, the test is executed in, for example, an environment where a DTV (Digital Television) 1 and a PC (Personal Computer) 2 are connected to each other through a network 3.

The DTV 1 is an apparatus on which an application to be tested is loaded. The DTV 1 loads an execution file prepared in the PC 2 through the network 3 and executes the execution file. Then, the test on a predetermined application loaded starts. DLL (Dynamic Link Library) or various kinds of data used for the test are appropriately loaded and acquired from the PC 2 or data areas prepared in the DTV 1.

For example, upon development of the application, an application to be loaded is read from the PC 2 and the test of the application is performed on the DTV 1.

On the DTV 1, an application that displays a menu screen for the sake of allowing a user to use various functions or an application that displays a program guide on the basis of EPG (Electronic Program Guide) data acquired by receiving broadcast waves is loaded upon shipment, and thus these applications are to be tested. Moreover, the application displaying the menu screen or the application displaying the program guide may be ported to other apparatuses than the DTV 1, and runs on platforms of other apparatuses.

For example, first, the application displaying the menu screen is read from the PC 2 and the test is performed thereon, and then the application displaying the program guide is read from the PC 2 and the test is performed thereon. That is, the test can be dividedly performed on the individual applications. Specifically, it is unnecessary to perform a test in such a manner that all applications to be loaded are combined in the DTV 1.

In the DTV 1, it is estimated whether or not the application to be tested performs an operation assumed according to an event, and a log indicating the estimation result is transmitted to the PC 2 through the network 3 at a predetermined timing.

The PC 2 is an apparatus serving as a development host of an application that is loaded on the DTV 1. In the PC 2, various kinds of data used for the test are prepared, in addition to the application to be tested (an application under development, which is to be loaded on the DTV 1), and the data is appropriately provided to the DTV 1 through the network 3 according to a request from the DTV 1.

As such, the event is automatically distributed (an event generated in the DTV 1 is distributed to the application to be tested), with no operation of a remote controller by a person, and the estimation of the application is performed on the basis of the event. Accordingly, the test of the application that is loaded on the DTV 1 can be performed without using person's hands.

Further, in the PC 2, as the data used for the test, data for the estimation of fine operations of the application, such as estimation of the operation of the application displaying the menu screen and the estimation of the operation of the application displaying the program guide, not the estimation of the coarse operations of the application, such as the estimation of the overall operation of the application loaded on the DTV 1, is prepared. Therefore, the tests of the individual application can be assigned to and performed by many people, and thus high work efficiency can be obtained.

In addition, the module that actually distributes the event is prepared in the PC 2 separately from the module that manages the entire test. Further, the modules that actually distribute the events are individually prepared in the PC 2 to correspond to a plurality of different platforms. Therefore, the module that manages the entire test is used for other purposes regardless of a difference between the platforms.

That is, even though an apparatus, on which the application to be tested is loaded, is the DTV 1 shown in FIG. 1, in an apparatus having a platform different from the DTV 1, such as a cellular phone, the module that distributes the event is changed according to the platform. Therefore, a part of data of the module that manages the entire test can be used for other purposes.

As described below in detail, a module that analyzes an event definition and inputs the event to an event distribution module (a module that actually distributes the event), and a module that analyzes the event definition peculiar to a platform are designed separately from the module that manages the entire test. Therefore, reusability of automatic execution definition of the test (the content of the test that is automatically performed) can be increased to the maximum, and a degree of freedom of event definition can be increased.

The event distribution definition describing which event is distributed at a timing is described, for example, in an XML (extensible Markup Language) so as for a person to easily understand. Therefore, a test manager can easily perform the event distribution definition compared with a case where the event distribution definition is prepared by a timing of event distribution and an ID representing the content of the event distributed at the timing, and thus costs for the event distribution definition can be reduced.

The modules that are prepared in the PC 2 and are used in the DTV 1 upon the test of the application will be described below.

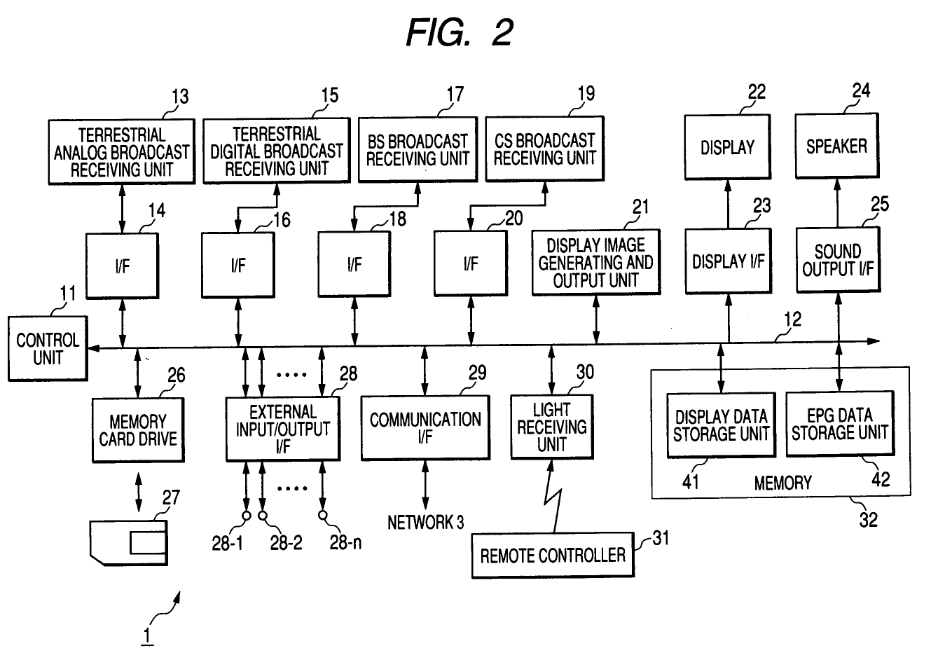

FIG. 2 is a block diagram showing an example of the hardware configuration of the DTV 1 shown in FIG. 1.

The DTV 1 has a control unit 11 that has a CPU (Central Processing Unit), a ROM (Read Only Memory), and a RAM (Random Access Memory), and the like, and individual processing units that are connected to the control unit 11 through a bus 12.

A terrestrial analog broadcast receiving unit 13 receives terrestrial analog television broadcast signals according to the control by the control unit 11, and outputs image signals (video signals) and sound signals obtained through demodulation to the bus 12 through an interface 14. An instruction to receive a channel selected by a user through the operation of a remote controller 31 is performed from the control unit 11 to the terrestrial analog broadcast receiving unit 13. Similarly, for other broadcast receiving units, an instruction according to the operation by the user is performed from the control unit 11.

A terrestrial digital broadcast receiving unit 15 corresponds to a digital television broadcast and a data broadcast, and receives a terrestrial digital broadcast according to the control of the control unit 11. The terrestrial digital broadcast receiving unit 15 outputs program image signals and sound signals, and EPG data obtained through decoding of a broadcast signal to the bus 12 through an interface 16.

A BS (Broadcasting Satellite) broadcast receiving unit 17 corresponds to a BS television broadcast, a BS voice broadcast (radio broadcast), and a data broadcast, and receives a BS digital broadcast according to the control of the control unit 11. The BS broadcast receiving unit 17 outputs program image signals and sound signals, and EPG data obtained through decoding of a broadcast signal to the bus 12 through an interface 18.

A CS (Communications Satellite) broadcast receiving unit 19 corresponds to a CS television broadcast, a CS voice broadcast, and a data broadcast, and receives a CS digital broadcast according to the control of the control unit 11. The CS broadcast receiving unit 19 outputs program image signals and sound signals, and EPG data obtained through decoding of a broadcast signal to the bus 12 through an interface 20.

A display image generating and output unit 21 causes a display 22 to display various images according to the control of the control unit 11. For example, the display image generating and output unit 21 causes the display 22 to display program images on the basis of image data supplied from the terrestrial analog broadcast receiving unit 13, the terrestrial digital broadcast receiving unit 15, the BS broadcast receiving unit 17, and the CS broadcast receiving unit 19 through the bus 12.

Further, the display image generating and output unit 21 has an OSD (On Screen Display) function, and causes the display 22 to display a menu screen, which is a GUI (Graphical User Interface) for causing the user to perform various operations using the DTV 1 according to the control of the control unit 11. Data of icons that are arranged on the menu screen, such as characters or symbols, are stored in a display data storage unit 41 of a memory 32.

The display 22 has an LCD (Liquid Crystal Display) or the like, and displays the program images, the menu screen, and the like according to the control of the display image generating and output unit 21 performed through the bus 12 and a display interface 23.

A speaker 24 outputs sound corresponding to sound data supplied from the terrestrial analog broadcast receiving unit 13, the terrestrial digital broadcast receiving unit 15, the BS broadcast receiving unit 17, and the CS broadcast receiving unit 19 through the bus 12 and a sound output interface 25 according to the control of the control unit 11 and the like.

A memory card drive 26 reads out data from a memory card 27 inserted into a slot formed in a casing of the DTV 1 and writes data into the memory card 27. For example, data of still pictures captured by a digital camera or the like are read out from the memory card 27.

An external input/output interface 28 performs data transmission and reception with apparatuses connected to external input/output terminals 28-1 to 28-n, such as a video input/output terminal, a sound input/output terminal, a USB (Universal Serial Bus) terminal, an IEEE (Institute of Electrical and Electronics Engineers) 1394 terminal, an HDMI (High-Definition Multimedia Interface) terminal, and the like, through various cables.

A communication interface 29 performs data transmission and reception with various apparatuses including the PC 2 through the network 3.

A light-receiving unit 30 receives infrared light from the remote controller 31 and outputs a signal corresponding to a user's operation obtained by demodulation to the control unit 11 through the bus 12. The remote controller 31 is provided with a cross key, a decision key, and a home key that is operated upon the display of the menu screen.

The memory 32 has a flash memory or the like, and is provided with a display data storage unit 41 and an EPG data storage unit 42. The display data storage unit 41 stores data of icons for displaying the menu screen, and the EPG data storage unit 42 stores EPG data acquired by the terrestrial analog broadcast receiving unit 13, the terrestrial digital broadcast receiving unit 15, the BS broadcast receiving unit 17, and the CS broadcast receiving unit 19.

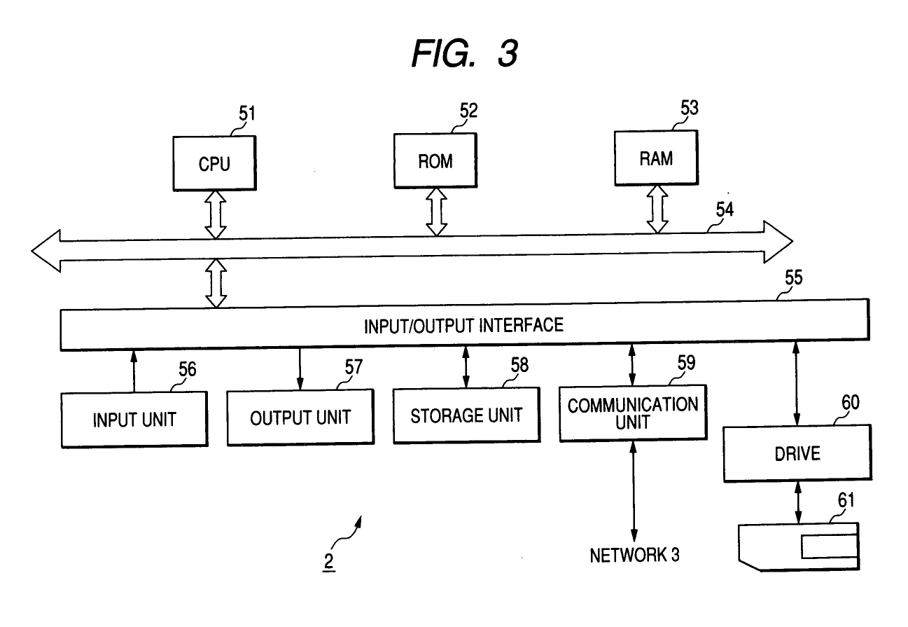

FIG. 3 is a block diagram showing an example of the configuration of the PC 2 shown in FIG. 1.

A CPU 51 executes various processings according to a program stored in a ROM 52 or a storage unit 58. The ROM 53 appropriately stores a program that is executed by the CPU 51 or data. The CPU 51, the ROM 52, and the RAM 53 are connected to one another through a bus 54.

An input/output interface 55 is connected to the CPU 51 through the bus 54. An input unit 56 having a keyboard, a mouse, a microphone, and the like, and an output unit 57 having a display, a speaker, and the like are connected to the input/output interface 55. The CPU 51 executes various processings corresponding to instructions input from the input unit 56. Then, the CPU 51 outputs the processing results to the output unit 57.

The storage unit 58 that is connected to the input/output interface 55 has, for example, a hard disk, and stores a program that is executed by the CPU 51 or various kinds of data that are supplied to the DTV 1 for the test. A communication unit 59 performs communication with, for example, the DTV 1 through the network 3, such as Internet or a local area network.

When a memory card 61 is mounted, a drive 60 that is connected to the input/output interface 55 acquires the program or data stored in the memory card 61 and writes a predetermined program or data into the memory card 61.

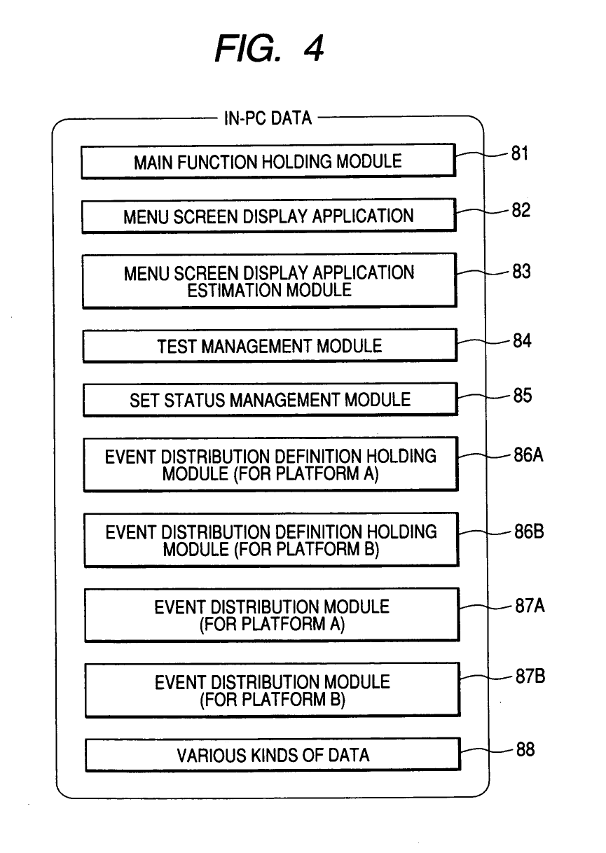

FIG. 4 is a diagram showing an example of data that is prepared in the PC 2 having the above configuration.

As shown in FIG. 4, in the PC 2, a main function holding module 81, a menu screen display application 82, a menu screen display application estimation module 83, a test management module 84, a set status management module 85, an event distribution definition holding module 86A (for a platform A), an event distribution definition holding module 86B (for a platform B), an event distribution module 87A (for a platform A), an event distribution module 87B (for a platform B), and various kinds of data 88 are prepared.

The main function holding module 81 is a module that holds a function common to a plurality of applications to be loaded on the DTV 1. As described above, although the application displaying the menu screen and the application displaying the program guide are loaded on the DTV 1, a function common to these applications is held. The test management module 84 described below is prepared as, for example, a part of the main function holding module 81.

The menu screen display application 82 is an application that is loaded on the DTV 1, displays the menu screen, and runs on the DTV 1 as a test object. That is, FIG. 4 shows an example of data that is prepared in the PC 2 when the operation of the menu screen display application among various applications loaded on the DTV 1 is tested. When the test of the application displaying the program guide (a program guide display application) is performed on the basis of EPG data, the program guide display application is prepared in the PC 2.

The menu screen display application estimation module 83 is a combination of test cases of the menu screen display application 82.

The test management module 84 is a module that is loaded on the DTV 1 so as to manage the entire test.

The test status management module 85 is a module that manages the status of the set (DTV 1), starts the application, and distributes events to the started application.

The event distribution definition holding module 86A is a module that holds event distribution definition information when the menu screen display application 82 to be tested runs on the platform A. As regards the events, even in the same event, a distribution destination varies or a distribution sequence varies by a difference between the platforms. When the menu screen display application 82 running on the platform A is to be tested, the event distribution definition holding module 86A holds distribution definition information indicating which event is distributed in which sequence.

The event distribution definition holding module 86B is a module that holds event distribution definition information when the menu screen display application 82 to be tested runs on the platform B.

As such, the module holding the event distribution definition information is prepared in the PC 2 for every platform, and is appropriately selected according to a platform on which the application to be tested runs.

The event distribution module 87A is a module that distributes, to the menu screen display application 82 to be tested running on the platform A, events directly or indirectly through other modules.

The event distribution module 87B is a module that distributes, to the menu screen display application 82 to be tested running on the platform B, events directly or indirectly through other modules.

As such, in the PC 2, the module that actually distributes the events is prepared for every platform, and is appropriately selected according to the platform on which the application to be tested runs.

Various kinds of data 88 are data, such as registry information or image files, required by the individual modules.

FIG. 5 is a block diagram showing an example of the functional configuration that is realized in the DTV 1 by loading a predetermined module among the modules shown in FIG. 4.

In FIG. 5, the same parts as those shown in FIGS. 2 and 4 are represented by the same reference numerals. In addition, numerals (numerals or ‘*’) that are appended to arrows connecting individual functional parts represent multiplicity. Moreover, in FIG. 5, it is assumed that the platform of the DTV 1, on which the application to be tested is loaded, is the platform A. Since the platform of the DTV 1 is the platform A, the modules for the platform A are selected as the event distribution module and the event distribution definition holding module.

The main function holding module 81 starts an update distribution module 91 when the test starts, for example.

In this example, the menu screen display application 82 is a module to be tested, performs a processing according to a distributed event, and changes a display status of the menu screen. The status change is estimated by the menu screen display application estimation module 83.

The menu screen display application estimation module 83 is loaded by the test management module 84, when an event is distributed from the event distribution module 87A to the menu screen display application 82, monitors whether or not the menu screen display application 82 is in an appropriate status accordingly, and estimates the status of the menu screen display application 82. For example, the menu screen display application estimation module 83 notifies the PC 2 of the estimation result each time one event is distributed.

In addition, the menu screen display application estimation module 83 appropriately requests the test management module 84 for interrupt/restart of event distribution or set an interface of the test management module 84.

The menu screen display application estimation module 83 having such a function is changed according to the event that is distributed to the menu screen display application 82. That is, the menu screen display application estimation module 83 can be attached to and detached from the test management module 84.

The test management module 84 is loaded from the main function holding module 81, and manages the entire test according to driving by the update distribution module 91. For example, upon loading, the test management module 84 acquires and sets paths of DLL files of the menu screen display application estimation module 83, the event distribution definition holding module 86A, and the event distribution module 87A from the registry 92 so as to load them.

The test management module 84 acquires an event to be next distributed from the event distribution definition holding module 86A and requests the event distribution module 87A for distribution of the acquired event. When the menu screen display application estimation module 83 ends the distribution of all estimatable events, the test management module 84 loads the next menu screen display application estimation module 83. This is sequentially repeated.

Moreover, the test management module 84 reads an event distribution definition file of an XML format, without depending on mounting of the event distribution definition holding module 86A, and uses the event distribution definition holding module 86A that generates an instance of a next event. Meanwhile, the test management module 84 reads an existing execution log and uses the event distribution definition holding module 86A that generates an instance of a next event. As such, the event distribution definition holding module 86A to be used can be changed.

In addition, when the DTV 1 is a set having one microcomputer, the test management module 84 uses the event distribution module 87A that performs event distribution to a system on its microcomputer, without depending on mounting of the event distribution module 87A. Meanwhile, when the DTV 1 is a set having two microcomputers, the test management module 84 uses the event distribution module 87A that requests for event distribution to another microcomputer. As such, the event distribution module 87A to be used can be changed.

The event distribution definition holding module 86A holds event distribution definition information indicating which event is distributed to the menu screen display application 82 running on the platform A in which sequence, and returns an event to be next distributed according to an inquiry from the test management module 84.

Moreover, when the application to be tested is one that runs on the platform B, not the platform A, the event distribution definition holding module 86B is used instead of the event distribution definition holding module 86A.

The event distribution module 87A distributes the event to the menu screen display application 82 running on the platform A according to the request from the test management module 84 or distributes the event to the entire set. The request from the test management module 84 includes information indicating which event is distributed, which is acquired by the event distribution definition holding module 86A. The event distribution to the menu screen display application 82 is performed, for example, through a remote controller receiving unit 93.

Moreover, when the application to be tested is one that runs on the platform B, not the platform A, the event distribution module 87B is used instead of the event distribution module 87A.

The update distribution module 91 has a timer function and periodically repeats callback (update distribution) according to the function registered by the test management module 84 such that the distributed event is transferred to the menu screen display application 82 as a module to be tested.

The remote controller receiving unit 93 distributes the event according to an instruction from the event distribution module 87A or an instruction from the light-receiving unit 30 that receives a signal from the remote controller 31.

Here, a series of steps that are performed by the individual functional units will be described with reference to FIG. 6.

At Step S1, the test management module 84 is loaded from the main function holding module 81, and then progresses to Step S2. At Step S2, a path of a DLL file of the event distribution module is acquired from the registry 92. When the menu screen display application 82 running on the platform A is to be tested, a path assigning the event distribution module 87A is set in the registry 92.

At Step S3, the test management module 84 loads the event distribution module 87A, and then progresses to Step S4. At Step S4, a path of a DLL file of the estimation module is acquired from the registry 92.

At Step S5, the test management module 84 loads the menu screen display application estimation module 83, and then progresses to Step S6. At Step S6, the test management module 84 opens its interface. For example, both the menu screen display application estimation module 83 and the test management module 84 have the interfaces, and the test management module 84 opens its interface through the interface registered by the menu screen display application estimation module 83, such that information exchange can be performed between them.

At Step S7, the menu screen display application estimation module 83 assigns a path of a DLL file of the event distribution definition holding module and initialization data of the event distribution definition holding module.

At Step S8, the test management module 84 loads the event distribution definition holding module 86A according to the assignment from the menu screen display application estimation module 83, and then progresses to Step S9. At Step S9, the event distribution definition holding module 86A is initialized using the data assigned from the menu screen display application estimation module 83. For example, the path of the file with the event defined therein is used as the initialization data. As such, the path of the DLL file of the event distribution definition holding module 86A may be acquired by the assignment from the menu screen display application estimation module 83, not acquired from the registry 92.

When the update distribution is performed from the update distribution module 91 at Step S10, at Step S11, the test management module 84 acquires the next event by the inquiry to the event distribution definition holding module 86A.

When the next event is normal event or direct event, the test management module 84 progresses to Step S12, and requests the event distribution module 87A for positing of the event (delivery of the event).

As the kinds of the event, for example, three kinds of normal event, direct event, and other event are defined. Further, information indicating which kind of event is the next event is acquired by the inquiry to the event distribution definition holding module 86A. Here, normal event is an event that is distributed to the application to be tested, and direct event is an event that is processed by the remote controller receiving unit 93. In addition, other event is an estimation event.

At Step S13, when the next event is normal event or direct event, the event distribution module 87A posts the event to the remote controller receiving unit 93.

At Step S14, when the next event is normal event or other event, the remote controller receiving unit 93 requests the event distribution for the set status management module 85. As shown in FIG. 5, other event is posted from the light-receiving unit 30 to the remote controller receiving unit 93, for example.

At Step S15, the set status management module 85 judges whether to distribute the event to the menu screen display application 82 or to process the event based on the set status by itself and then, when the requested event is other event, progresses to Step S16. At Step S16, the set status is changed by starting the menu screen display application 82 or the like.

For example, when an event corresponding to the push of the home key provided in the remote controller 31 is delivered, the set status management module 85 starts the menu screen display application 82. In this state, the event can be distributed to the menu screen display application 82.

Meanwhile, at Step S15, when it is judged that the requested event is normal event, the set status management module 85 progresses to Step S17. At Step S17, the event is distributed to the menu screen display application 82.

At Step S18, the test management module 84 notifies the menu screen display application estimation module 83 that the event is distributed to the menu screen display application 82.

At Step S19, the menu screen display application estimation module 83 estimates the status of the menu screen display application 82 and acquires the estimation result. The acquired estimation result is provided to the PC 2 at a predetermined timing.

Steps S10 to S19 among a series of steps described above are repeated each time the event is acquired. When the event cannot be acquired at Step S11 (when all the events are processed), the menu screen display application estimation module 83 that has been loaded at that time is discharged. Further, when a next estimation module for estimating the menu screen display application 82 exists, Steps 5 and the subsequent steps are sequentially performed using that estimation module.

Moreover, Steps S13 to S17 may be appropriately substituted with other steps for event distribution by design the event distribution module 87A.

With this processing, the test management module 84 leading in the automatic test can be used for other purposes, regardless of the difference between the platforms. Therefore, a module for an automatic test of an application running on a plurality of platforms can be realized in a portable form.

Further, it is unnecessary to prepare the event distribution definition for testing the operation of the entire application loaded on the DTV 1. It is sufficient to prepare the event distribution definition for a part.

Moreover, among event distribution definition files (XML files), the kind of each event is assigned by an event definition name that is generally defined by a system that is ported to the plurality of platforms. As for the event peculiar to the platform, event definition is separately defined.

The analysis of the event distribution definition file with the event peculiar to the platform described therein can be changed for every platform. Then, portability can also be applied to the event distribution definition file.

For example, a translation module that serves as a dictionary for translating the event content described in the event distribution definition file into codes to be analyzed by the event distribution module may be separately provided, and the translation module may be used by the event distribution definition holding module. With this configuration, the analysis of the event distribution definition file can be changed for every platform.

Moreover, in this case, the translation module may not be mounted on the event distribution definition holding module. For example, the translation module may be attached to and detached from the event distribution definition holding module.

In the above description, although various kinds of data used for the test of the application are provided from the PC 2 to the DTV 1 through the network 3, the data may be provided through the memory card 61 of FIG. 3. In this case, the data is provided by inserting the memory card 61, into which various kinds of data are written by the PC 2, into the slot formed in the casing of the DTV 1 and reading out the stored data by the DTV 1.

It should be understood by those skilled in the art that various modifications, combinations, sub-combinations and alterations may occur depending on design requirements and other factors insofar as they are within the scope of the appended claims or the equivalents thereof.

1. A test management program that causes a computer to execute a process, the process comprising:
selecting from among modules prepared for a plurality of platforms, a distribution definition holding module that holds a distribution definition of an event and a distribution module that distributes the event, according to a platform on which an application to be tested runs;
causing the distribution module to distribute the event to the application to be tested according to the distribution definition held by the selected distribution definition holding module; and
estimating the state of the application to which the event is distributed.

2. The test management program according to claim 1, wherein the process further comprises:
selecting from among estimation modules prepared for a plurality of applications as modules estimating the state of the application, an estimation module for the application to be tested, wherein the selected estimate module estimates the state of the application to which the event is distributed.

3. The test management program according to claim 1, wherein the test management program is prepared in a computer serving as a development host of the application to be tested and is executed by an electrical apparatus on which the application is loaded.

4. The test management program according to claim 3, wherein the test management program is provided from the computer to the electrical apparatus through a network.

5. The test management program according to claim 1, wherein the distribution definition is described in an XML format.

6. A test management method of an application, the method comprising:
selecting from among modules prepared for a plurality of platforms, a distribution definition holding module that holds a distribution definition of an event and a distribution module that distributes the event, according to a platform on which an application to be tested runs;
causing the distribution module to distribute the event to the application to be tested according to the distribution definition held by the selected distribution definition holding module; and
estimating the state of the application to which the event is distributed.
